(19) United States
(12) Patent Application Publication
(10) Pub. No.: US 2016/0305184 A1
(43) Pub. Date: Oct. 20, 2016

(54) Curtain blade

(71) Applicant: Ching-Piao CHEN, Toufen City (TW)

(72) Inventor: Ching-Piao CHEN, Toufen City (TW)

(21) Appl. No.: 15/079,058

(22) Filed: Mar. 24, 2016

(30) Foreign Application Priority Data
Apr. 17, 2015 (CN) 201520230453.3

(51) Int. Cl. E06B 9/386; E06B 9/266; E06B 9/26

(52) U.S. Cl. CPC E06B 9/386; E06B 9/26; E06B 9/266

(57) ABSTRACT

A curtain blade contains: a body and a two reinforcement ribs. The body is made of any one of bamboo veneer, wood veneer, and linen fabric and includes two long sides, wherein each reinforcement rib is covered on each of the two long sides of the body so as to reinforce said each long side. Said each reinforcement rib has an accommodation groove defined therein and corresponding to said each long side of the body, hence said each reinforcement rib is fitted on said each long side, and said each long side of the body inserts into the accommodation groove. The curtain blade is therefore fixed firmly and obtains aesthetic appearance. Preferably, said each reinforcement rib protects said each long side of the body effectively so as to prolong service life of the curtain blade.

### FIELD OF THE INVENTION

The present invention relates to a curtain blade which is fixed firmly and obtains aesthetic appearance.

### BACKGROUND OF THE INVENTION

A conventional curtain blade is integrally molded from plastic material, but it is difficult to clean the conventional curtain blade completely. In addition, it is easy to causes environment pollution as manufacturing the curtain blade from the plastic material.

Also, the curtain blade, made of the plastic material, cannot be decomposed after being discarded.

To overcome above-mentioned problems, an improved curtain blade, made of bamboo or wood, has been developed. However, such an improved curtain blade is in a flat plate shape and is cumbersome and it is manufactured at high production cost. Likewise, the improved curtain blade is broken easily because its two peripheral sides are not covered.

The present invention has arisen to mitigate and/or obviate the afore-described disadvantages.

### SUMMARY OF THE INVENTION

The primary objective of the present invention is to provide a curtain blade which is fixed firmly and obtains aesthetic appearance.

Another objective of the present invention is to provide a curtain blade in which each of two reinforcement ribs protects each of two long sides of a body effectively so as to prolong service life of the curtain blade.

To obtain the above objectives, a curtain blade provided by the present invention contains: a body and two reinforcement ribs.

The body is made of any one of bamboo veneer, wood veneer, and linen fabric and including two long sides.

Each reinforcement rib is covered on each of the two long sides of the body so as to reinforce said each long side.

Said each reinforcement rib has an accommodation groove defined therein and corresponding to said each long side of the body, hence said each reinforcement rib is fitted on said each long side, and said each long side of the body inserts into the accommodation groove.

Preferably, an adhesive glue layer is coated in the accommodation groove of said each reinforcement rib so that said each long side of the body in the accommodation groove is adhered with said each reinforcement rib.

### BRIEF DESCRIPTION OF THE DRAWINGS

FIG. 1 is a perspective view showing the assembly of a curtain according to a preferred embodiment of the present invention.

FIG. 2 is a side plan view showing the assembly of the curtain blade according to the preferred embodiment of the present invention.

### DETAILED DESCRIPTION OF THE PREFERRED EMBODIMENTS

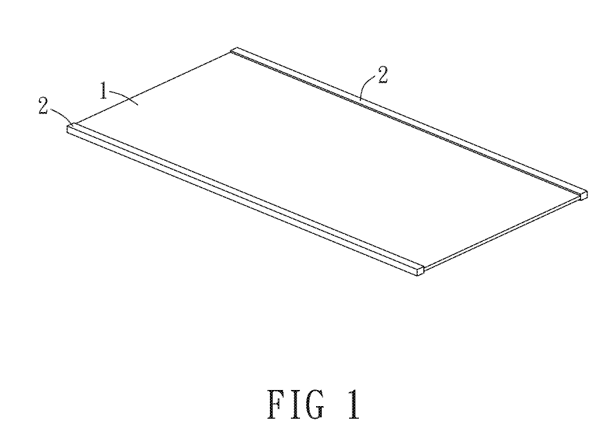

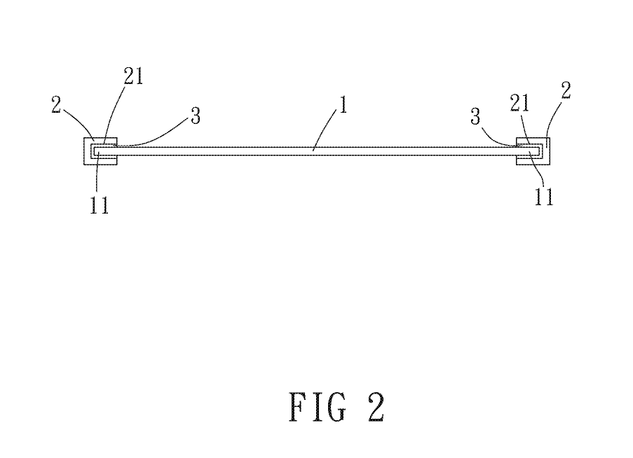

With reference to FIGS. 1 and 2, a curtain blade according to a preferred embodiment of the present invention comprises: a body 1 and two reinforcement ribs 2, wherein the body 1 includes two long sides 11 corresponding to the two reinforcement ribs 2 and is made of any one of bamboo veneer, wood veneer, and linen fabric, wherein the body 1 is in any one of square, oval, and arc shapes so as to satisfy a variety of using requirements. Each reinforcement rib 2 is molded from bamboo or other materials and is covered on each of the two long sides 11 of the body 1 so as to reinforce said each long side 11.

Referring further to FIG. 2, said each reinforcement rib 2 has an accommodation groove 21 defined therein and corresponding to said each long side 11 of the body 1, hence said each reinforcement rib 2 is fitted on said each long side 11, and said each long side 11 of the body 1 inserts into the accommodation groove 21. Furthermore, an adhesive glue layer 3 is coated in the accommodation groove 21 of said each reinforcement rib 2 so that said each long side 11 of the body 1 in the accommodation groove 21 is adhered with said each reinforcement rib 21 securely. Thereby, the curtain blade is fixed firmly and obtains aesthetic appearance. Preferably, said each reinforcement rib 2 protects said each long side 11 of the body 1 effectively so as to prolong service life of the curtain blade.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A curtain blade comprising: a body and a two reinforcement ribs;
the body being made of any one of bamboo veneer, wood veneer, and linen fabric and including two long sides;
wherein each reinforcement rib is covered on each of the two long sides of the body so as to reinforce said each long side.

2. A curtain blade comprising: a body and a two reinforcement ribs;
the body being made of any one of bamboo veneer, wood veneer, and linen fabric and including two long sides;
wherein each reinforcement rib is covered on each of the two long sides of the body so as to reinforce said each long side;
wherein said each reinforcement rib has an accommodation groove defined therein and corresponding to said each long side of the body, hence said each reinforcement rib is fitted on said each long side, and said each long side of the body inserts into the accommodation groove.

3. The curtain blade as claimed in claim 2, wherein an adhesive glue layer is coated in the accommodation groove of said each reinforcement rib so that said each long side of the body in the accommodation groove is adhered with said each reinforcement rib.
